(19) United States
(12) Patent Application Publication
(10) Pub. No.: US 2026/0017004 A1
(43) Pub. Date: Jan. 15, 2026

(54) RENDERING METHOD, ELECTRONIC DEVICE AND NON-TRANSITORY COMPUTER-READABLE STORAGE MEDIUM

(71) Applicant: Beijing Zitiao Network Technology Co., Ltd., Beijing (CN)

(72) Inventors: Jinchang CHEN, Beijing (CN); Wenhui SHENG, Beijing (CN); Xuxing ZHAO, Beijing (CN); Wei FU, Beijing (CN)

(21) Appl. No.: 19/265,552

(22) Filed: Jul. 10, 2025

(30) Foreign Application Priority Data
Jul. 10, 2024 (CN) 202410920614.5

(51) Int. Cl. G06F 3/14

(52) U.S. Cl. CPC G06F 3/14

(57) ABSTRACT

A rendering method, an electronic device and a non-transitory computer-readable storage medium are provided. The rendering method includes: determining a target rendering resource identifier corresponding to at least one client based on a resource identifier acquisition instruction sent by the at least one client; sending the target rendering resource identifier to the at least one client; receiving a rendering instruction sent by the at least one client, wherein the rendering instruction includes the target rendering resource identifier; and rendering a target rendering resource according to the target rendering resource identifier to obtain a rendering result, and sending the rendering result to a corresponding client of the at least one client.

This application claims priority from China Patent Application No. 202410920614.5 filed on Jul. 10, 2024, and the disclosure of the above-mentioned China Patent Application is hereby incorporated in its entirety as a part of this application.

### TECHNICAL FIELD

Embodiments of the present application relate to the technical field of Internet, in particular to a rendering method and apparatus, an electronic device and a non-transitory computer-readable storage medium.

### BACKGROUND

Applications (APP) serve as clients that provide users with various images during runtime, such as functional pages and operational interfaces, allowing users to interact with the clients based on the images.

Currently, the various images presented to users by the client can be rendered through the following method: the client first parses an XML layout file into an object DisplayList, which is an object that a graphics processing unit (GPU) can recognize and draw; here, the object DisplayList serves as a cache area for drawing commands, recording a sequence of drawing commands to be executed and containing all the data required for the GPU to draw onto a screen; the object DisplayList includes a method drawXXX( ) of the canvas, and the method drawXXX( ) represent a drawing method XXX; next, the GPU renders the object DisplayList to draw the content represented by the object DisplayList onto a graphics rendering unit Surface, the Surface, also known as the on-Screen Rendering Surface, specifically refers to a segment of memory that stores a rendering result and is associated with a window; finally, the rendering result drawn on the Surface are composited by a display engine compositor and shown on the screen.

However, when multiple clients perform image rendering simultaneously on the same device, it is necessary for each client to conduct independent rendering according to the above-mentioned method, resulting in a waste of GPU computational resources.

### SUMMARY

Embodiments of the present application provides a rendering method and apparatus, an electronic device and a non-transitory computer-readable storage medium, and can improve the utilization of GPU computing resources of graphics processor.

In a first aspect, at least an embodiment of the application provides a rendering method, which is applied to an electronic device, and the electronic device comprises a server, and the server executes the rendering method, and the method comprises:
determining a target rendering resource identifier corresponding to at least one client based on a resource identifier acquisition instruction sent by the at least one client;
sending the target rendering resource identifier to the at least one client;
receiving a rendering instruction sent by the at least one client, wherein the rendering instruction comprises the target rendering resource identifier; and
rendering a target rendering resource according to the target rendering resource identifier to obtain a rendering result, and sending the rendering result to a corresponding client of the at least one client.

In a second aspect, an embodiment of the application provides a rendering apparatus configured in an electronic device, the electronic device includes a server and the server executes the rendering device, comprising:
an information determination module, configured to determine a target rendering resource identifier corresponding to at least one client based on a resource identifier acquisition instruction sent by the at least one client;
an information sending module, configured to send the target rendering resource identifier to the at least one client;
an instruction receiving module, configured to receive a rendering instruction sent by the at least one client, the rendering instruction comprising the target rendering resource identifier; and
a rendering module, configured to render a target rendering resource according to the target rendering resource identifier to obtain a rendering result, and send the rendering result to a corresponding client of the at least one client.

In a third aspect, at least an embodiment of the application provides an electronic device, which comprises:
a processor and a memory, the memory is configured to store a computer instruction, and the processor is configured to call and run the computer program stored in the memory to execute the rendering method according to the above-mentioned embodiment of the first aspect.

In a forth aspect, at least an embodiment of the application provides a non-transitory computer-readable storage medium containing computer-executable instructions, the computer-executable instructions, when executed by a computer processor, are used to execute the rendering method according to the above-mentioned embodiment of the first aspect.

In a fifth aspect, at least an embodiment of the application provides a computer program product containing program instructions, the program instruction, when run on an electronic device, causes the electronic device to perform the rendering method as described in the embodiment of the first aspect.

The technical scheme disclosed in the embodiments of the present application determines target rendering resource identifier corresponding to at least one client based on resource identifier acquisition instruction sent by the at least one client; sends the target rendering resource identifier to the at least one client; and upon receiving rendering instruction sent by the at least one client, renders target rendering resource according to the target rendering resource identifier carried in the rendering instruction to obtain rendering result, and sends the rendering result to the corresponding client. By utilizing a server to uniformly manage the rendering instruction sent by each client and centrally execute rendering tasks corresponding to the rendering instruction, the technical scheme eliminates the need for each client to invoke a GPU for independent rendering, thereby avoiding the waste of GPU computational resources and improving the utilization rate of GPU computational resources. Additionally, the present application also uniformly manages rendering resources required by each client through the server, which improves rendering efficiency when the server executes the rendering tasks corresponding to the rendering instruction, and also allows for the reuse of rendering resources, thereby enhancing the utilization rate of rendering resources.

### BRIEF DESCRIPTION OF DRAWINGS

In order to explain the technical scheme in the embodiment of the application more clearly, the drawings needed in the description of the embodiment are briefly introduced below. Obviously, the drawings in the following description are only some embodiments of the application. For ordinary persons skilled in the art, other drawings can be obtained according to these drawings without creative work.

FIG. 1 is a flow diagram of a rendering method according to an embodiment of the present application;

FIG. 2 is a schematic diagram of a server according to an embodiment of the present application;

FIG. 3 is a flow diagram for determining target rendering resource identifier according to an embodiment of the present application;

FIG. 4 is a flow diagram of another rendering method according to an embodiment of the present application;

FIG. 5 is a schematic diagram of rendering operations performed by a server on rendering tasks sent by multiple clients according to an embodiment of the present application;

FIG. 6 is a schematic block diagram of a rendering apparatus according to an embodiment of the present application; and

FIG. 7 is a schematic block diagram of an electronic device according to an embodiment of the present application.

### DETAILED DESCRIPTION

The technical scheme in the embodiments of the present application will be clearly and completely described below in combination with attached drawings. Obviously, the described embodiments are only part of the embodiments of the present application, not all of them. Based on the embodiments of the present application, all other embodiments obtained by those of ordinary skill in the art without making creative labor belong to the scope of protection of the present application.

It should be noted that the terms “first” and “second” in the specification and claims of the present application and the drawings are used to distinguish similar objects, and are not necessarily used to describe a specific order or sequence. It should be understood that the data thus used are interchangeable under appropriate circumstances, so that the embodiments of the present application described herein can be implemented in other orders than those illustrated or described herein. Furthermore, the terms “comprise” and “have” and any variations thereof are intended to cover non-exclusive inclusion, for example, a process, method, system, product or server that comprises a series of steps or units is not necessarily limited to those explicitly listed, but may comprise other steps or units not explicitly listed or inherent to such process, method, product or device.

In the embodiments of the application, terms such as “exemplary” or “for example” are used to indicate examples or instances for illustration or explanation. Any embodiment or scheme disclosed as “exemplary” or “for example” in the embodiments of the application should not be interpreted as being more preferred or advantageous than other embodiments or schemes. Specifically, the use of terms such as “exemplary” or “for example” is intended to present relevant concepts in a specific manner.

In the description of the embodiments of the present application, unless otherwise specified, “multiple” refers to two or more, that is, at least two; “at least one” means one or more; and “any” means any one or several.

In the related art, when a client provides users with various images, such as functional pages and operational interfaces, the client first parses an XML layout file into an object DisplayList, which is an object that a GPU can recognize and draw; next, the GPU renders the object DisplayList to draw the content represented by the object DisplayList onto a graphics rendering unit, Surface; finally, the rendering result drawn on the Surface are composited by a display engine compositor and shown on a screen. However, when multiple clients perform image rendering simultaneously on the same device, it is necessary for each client to conduct independent rendering according to the previously mentioned method, resulting in a waste of GPU computational resources.

To resolve the technical problems mentioned above, the present application provides a rendering method and apparatus, a device and a medium, which are designed to tackle the issue of GPU computational resource wastage arising from each client conducting independent rendering based on traditional rendering methods when multiple clients perform image rendering simultaneously on the same device, ultimately enhancing the utilization rate of GPU computational resources.

The technical scheme of the present application will be described in detail with specific embodiments. The following embodiments may be combined with each other, and the same or similar concepts or processes may not be repeated in some embodiments.

FIG. 1 is a flow diagram of a rendering method according to an embodiment of the present application. The rendering method provided by the embodiment of the present application is applied to an electronic device, the electronic device includes a server, and the rendering method is executed by the server. Here, the server may be a service program which performs rendering tasks based on rendering instruction sent by any client. Moreover, the service program may be understood as an application program providing rendering services. In other words, the server is a server APP.

In the present application, the electronic device may be a terminal device or a server, and when the electronic device is a terminal device, the terminal device may be, but not limited to, a smart phone, a tablet computer, a desktop computer, a computer device and the like. When the electronic device is a server, the server may be a single server or a server cluster, etc., and the single server may be a physical server or a cloud server, etc. There is no specific restriction on the type of electronic device here. As shown in FIG. 1, the rendering method may include the following steps.

S101, determining a target rendering resource identifier corresponding to at least one client based on a resource identifier acquisition instruction sent by the at least one client.

S102, sending the target rendering resource identifier to the at least one client.

The at least one client is specifically an application program of any type, that is, the client is a client APP, and the at least one client may be installed on an electronic device where the server is located or on other electronic devices except the electronic device where the server is located. The client may be at least one of a 2D application program and a 3D application program.

That is, the at least one client and the server may be installed on the same electronic device or on different electronic devices.

For example, assuming that the electronic device on which the server is installed is any terminal device, the at least one client may also be installed on the terminal device. For another example, assuming that the electronic device on which the server is installed is a server, the at least one client may be installed on any terminal device except the server. There is no specific restriction on the types of electronic devices for installing the server and the clients.

In the present application, the target rendering resource identifier may be understood as the unique information of the target rendering resource, such as a unique code or serial number of the target rendering resource, which is not limited here.

Considering that some terminal devices can support the simultaneous operation of multiple clients through split-screen mode and other methods, when at least one client installed on the terminal device needs to display a target image (such as a new operating interface or new display screen) to users during concurrent operation, each client may first acquire rendering resources corresponding to the target image, then, according to a data verification algorithm agreed upon beforehand with the server, verification information of the rendering resources is calculated, and subsequently, resource identifier acquisition instructions are generated based on the verification information of the rendering resources and sent to the server communicating with each client, allowing the server to determine corresponding target rendering resource identifier based on the resource identifier acquisition instruction sent by each client. The target rendering resource identifier may be understood as the unique information of the rendering resources corresponding to the target image. In other words, the target rendering resource identifier serves as the identity information of the target rendering resources.

In the present application, each client may acquire the rendering resources corresponding to the target image either from a local storage unit or from a resource database on the server side communicating with the client, which is not limited by the present application.

And, the data verification algorithm agreed upon beforehand by each client and the server may be any algorithm that detects the consistency of rendering resources, such as the cyclic redundancy check (CRC) algorithm, secure hash algorithm (SHA), and message-digest algorithm (MD). Here, SHA includes SHA0 and SHA1, while MD includes MD1, MD2, MD3, MD4, and MD5. In the present application, when the data verification algorithm is SHA, SHA1 is preferred. When the data verification algorithm is MD, MD5 is preferred.

That is, in the case where the data verification algorithm is CRC, each client calculates the verification information of the rendering resources as a CRC check code. In the case where the data verification algorithm is SHA, each client calculates the verification information of the rendering resources as an SHA value. In the case where the data verification algorithm is MD, each client calculates the verification information of the rendering resources as an MD value. In other words, the verification information of the rendering resources is one selected from a group consisting of CRC check code, SHA value, or MD value.

In some alternative embodiments, after receiving the resource identifier acquisition instruction sent by the at least one client, the server may acquire the verification information of the rendering resources (that is, the verification information of the target rendering resource) from each resource identifier acquisition instruction by parsing the resource identifier acquisition instruction sent by each client. Subsequently, according to the verification information of the target rendering resource, the server searches within its own resource management module for rendering resources identical to the verification information. Then, the rendering resource identifier are returned to the corresponding client as the target rendering resource identifier.

The rendering resource(s) specifically refer to rendering resource data. The format of the rendering resource data may be at least one selected from the group consisting of the following: GLB files, GLTF files, OBJ format, and images. Here, the GLB file is a binary file in the GL transmission format, which serves as a standardized file format for sharing 3D data. The GLB file may include information such as 3D models, scenes, and materials. The GLTF file is a JSON file used to describe the content of a 3D scene, including a scene graph that describes the structure of the scene. The OBJ format is a file format for 3D models.

In the present application, the resource management module stores at least two rendering resources, and each rendering resource is stored according to a corresponding relationship among rendering resource identifier, verification information and the rendering resource itself. In other words, the storage format for the rendering resource may be selected from the group consisting of {Rendering Resource Identifier; Verification Information; Rendering Resource}.

As an example, the resource information stored by the resource management module may be as shown in Table 1 below.

TABLE 1

| | Rendering resource | |
|---|---|---|
| Verification information | identifier | Rendering resource |
| CRC check code 1 | ID1 | xxxxxxxx1 |
| MD value 1 | ID2 | xxxxxxxx2 |
| CRC check code 2 | ID3 | xxxxxxxx3 |
| . . . | . . . | . . . |
| SHA value 1 | IDn | xxxxxxxxn |

In the present application, the plurality of rendering resources stored in the resource management module may be acquired through one of the following methods.

Method 1: During the initial run of each client in the terminal device, each client may send all the rendering resources for all the images it needs to render to the server, which allows the server to allocate the identifier and the verification information for each rendering resource and store the rendering resource according to the corresponding relationship among the rendering resource identifier, the verification information and the rendering resource.

Method 2: During the initial run of each client in the terminal device, each client may send the storage addresses of all the rendering resources for the images it needs to render to the server, which allows the server then to acquire the corresponding rendering resources based on the storage addresses. Subsequently, the server allocates the identifier and verification information for each acquired rendering resource and stores the rendering resource according to the corresponding relationship among the rendering resource identifier, verification information and the rendering resource.

It should be noted that after allocating verification information for each rendering resource, the server may provide the specific implementation method of allocating verification information (such as the verification information calculation algorithm) for each rendering resource to the client corresponding to each rendering resource, which allows the client to subsequently calculate the verification information of the target rendering resource based on the verification information calculation algorithm provided by the server. The verification information calculation algorithm specifically refers to any of the aforementioned algorithms used to detect the consistency of rendering resources.

S103, receiving a rendering instruction sent by the at least one client, wherein the rendering instruction comprises the target rendering resource identifier.

S104, rendering a target rendering resource according to the target rendering resource identifier to obtain a rendering result, and sending the rendering result to a corresponding client of the at least one client.

In some alternative embodiments, after the server returns the target rendering resource identifier requested by each client to the corresponding client, each client may generate a rendering instruction according to the target rendering resource identifier returned by the server and send the rendering instruction to the server, allowing the server to perform rendering operations according to the rendering instruction sent by each client.

Alternatively, after receiving the rendering instruction sent by each client, the server may parse each rendering instruction to obtain the target rendering resource identifier from each rendering instruction. Further, the target rendering resource corresponding to the target rendering resource identifier are acquired from the resource management module according to the target rendering resource identifier. Then, a GPU is invoked to render the target rendering resource to obtain rendering result. Subsequently, the rendering result are returned to the corresponding client, allowing the client to display images according to the rendering result, that is, the client displays the rendering result on a screen.

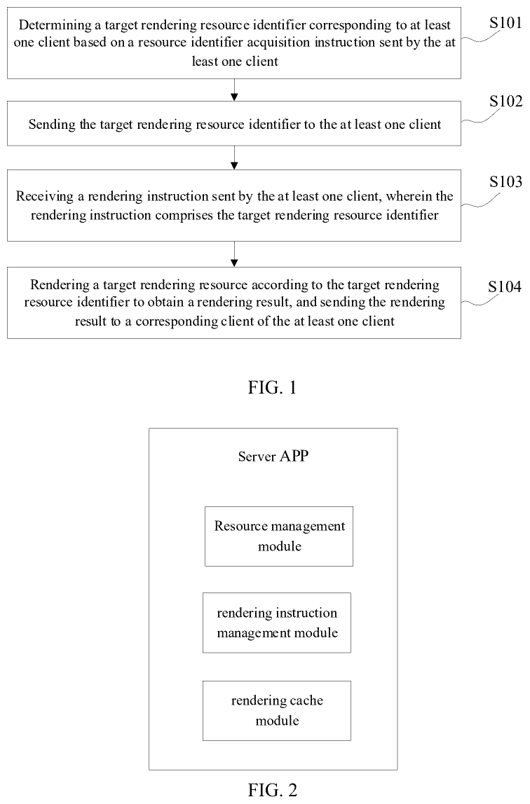

In some alternative embodiments, after the rendering result are obtained, the server may also store the rendering result into a rendering cache module according to a corresponding relationship between the target rendering resource identifier and the rendering result. Here, the rendering cache module in the server may be as shown in FIG. 2. In this way, in response to the client rendering the rendering resource corresponding to the same rendering resource identifier again, that is, in response to a rendering result of the same rendering resource identifier being acquired, the server may acquire the corresponding rendering result from the rendering cache module according to the target rendering resource identifier and return the same to the client, thus realizing the reuse of the rendering result, avoiding the repeated rendering of the same rendering resource by the GPU, and saving GPU computational resources.

As an example, the rendering result stored in the rendering cache module may be as shown in the following table 2.

TABLE 2

| No. | Rendering resource identifier | Rendering result |
|---|---|---|
| 1 | ID1 | YY1 |
| 2 | ID2 | YY2 |
| . . . | . . . | . . . |
| m | IDm | YYm |

In the present application, the rendering result stored in the rendering cache module of the server may support dynamic updating and deletion operations. The dynamic updating refers to the process where, each time a new rendering result is generated and the new rendering result is not already cached in the rendering cache module, the server may add the new rendering result to the rendering cache module to achieve dynamic updating of the rendering cache module. The deletion operation takes into account that the storage space of the rendering cache module is limited, and some rendering results may no longer be used as the client updates, therefore, the server may monitor the reuse time and frequency of the cached rendering result in the rendering cache module. In response to detecting that any rendering result has not been used for more than a preset duration, it can be considered that the rendering result may not be used again with the update of the client, in this case, the rendering result may be deleted from the rendering cache module to free up space for storing other rendering results. The preset duration is an adjustable parameter and may be dynamically set based on the update situation of the client, such as 6 months or 12 months, which is not limited here.

It should be noted that in the present application, the determination of the target rendering resource identifier and the execution of rendering tasks in the server may be implemented as two serial threads or as two parallel threads. Here, the determination of the target rendering resource identifier may be referred to as an identifier acquisition thread, and the execution of rendering tasks may be referred to as a rendering thread.

In some alternative embodiments, in response to the identifier acquisition thread and the rendering thread operating as parallel threads, the server may execute the rendering thread simultaneously while performing the identifier acquisition thread, thereby improving the rendering efficiency.

The technical scheme disclosed in the embodiments of the present application determines target rendering resource identifier corresponding to at least one client based on resource identifier acquisition instruction sent by the at least one client, sends the target rendering resource identifier to the at least one client, and upon receiving the rendering instruction sent by the at least one client, renders the target rendering resource according to the target rendering resource identifier carried in the rendering instruction to obtain the rendering result, and sends the rendering result to the corresponding client. By utilizing a server to uniformly manage the rendering instruction sent by each client and centrally execute rendering tasks corresponding to the rendering instruction, the technical scheme eliminates the need for each client to invoke a GPU for independent rendering, thereby avoiding the waste of GPU computational resources and improving the utilization rate of GPU computational resources. Additionally, the present application also uniformly manages rendering resources required by each client through the server, which improves rendering efficiency when the server executes the rendering tasks corresponding to the rendering instruction, and also allows for the reuse of rendering resources, thereby enhancing the utilization rate of rendering resources.

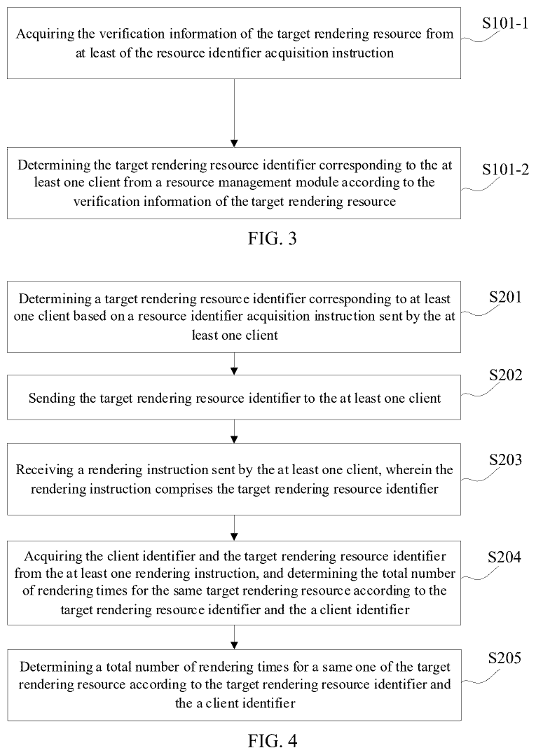

How the server determines the target rendering resource identifier based on the resource identifier acquisition instruction sent by each client will be further explained below with reference to FIG. 3. As shown in FIG. 3, the aforementioned step S101 includes the following steps S101-1 and S101-2.

S101-1, acquiring the verification information of the target rendering resource from at least of the resource identifier acquisition instruction.

S101-2, determining the target rendering resource identifier corresponding to the at least one client from a resource management module according to the verification information of the target rendering resource.

In some alternative embodiments, after acquiring the verification information of the target rendering resource from each parsed resource identifier acquisition instruction, the server may acquire a candidate rendering resource identical to the verification information in the resource management module according to the verification information of the target rendering resource, and determine the candidate rendering resource identifier corresponding to the candidate rendering resource as the target rendering resource identifier.

As an alternative implementation, the server may determine the target rendering resource identifier from the resource management module by querying whether there is a rendering resource in the resource management module identical to the verification information of the target rendering resource based on the verification information of the target rendering resource. If it is found that there is a rendering resources in the resource management module identical to the verification information of the target rendering resource, the rendering resource is determined to be the candidate rendering resource, and the identifier of the candidate rendering resource is designated as the target rendering resource identifier. If it is not found that there is a rendering resources in the resource management module identical to the verification information of the target rendering resource, it indicates that the target rendering resource is not stored in the resource management module, in this case, the server may send a target rendering resource acquisition request to the client acquiring the target rendering resource identifier, allowing the client to send the target rendering resource to the server based on the target rendering resource acquisition request. Subsequently, the server stores the target rendering resource sent by the client in its own resource management module according to the corresponding relationship among rendering resource identifier, verification information and rendering resource, and provides the target rendering resource identifier to the client.

Considering that the character length of the verification information of the rendering resource is fixed, the server may concatenate the verification information of each rendering resource at a preset position of each rendering resource when storing the rendering resources in the resource management module. In this way, when searching for the target rendering resource identifier in the resource management module, the server may read the verification information at the preset position of each rendering resource in the resource management module according to the method of file offset, and consequently, there is no need to read the entire content of each rendering resource in the resource management module, and only part of the content of each rendering resource needs to be read, thus increasing the speed of obtaining the target rendering resource identifier.

In some alternative embodiments, when the server concatenates the verification information of each rendering resource at a preset position of each rendering resource, the preset position may be at the end or the beginning of each rendering resource, among others, which is not limited by the present application.

In some alternative embodiments, when the client acquiring the target rendering resource identifier sends the target rendering resource to the server based on the target rendering resource acquisition request, the method may include one of the following two situations.

In the first situation, the client may only send the target rendering resource to the server, so that the server can allocate identifier information and verification information to the target rendering resource. Here, the allocation of identifier information may be realized according to identifier allocation rules, and the allocated verification information may be calculated for the target rendering resource according to a data verification algorithm agreed upon with the clients beforehand.

In the second situation, the client may send the target rendering resource and the verification information of the target rendering resource together to the server, so that after receiving the target rendering resource and the verification information of the target rendering resource, the server only needs to allocate the identifier information to the target rendering resource according to the identifier allocation rules.

It should be noted that the identifier allocation rules mentioned above may be any strategy or method for assigning unique information for the rendering resources, which is not limited here.

In this embodiment, the server utilizes the resource management module to uniformly manage the rendering resources required for each client, so that when the client performs rendering operations through the server, the client only needs to send a particular rendering resource to the server once, which eliminates the need for each client to send the same rendering resource to the server whenever each client requires the same rendering resource for rendering, thereby preventing the clients from redundantly sending the same rendering resource to the server, thus reducing data transmission costs and enhancing the rendering speed of the rendering resources.

In some alternative embodiments, considering that the rendering instructions sent by different clients may result in repeated rendering of the same rendering resource, the present application may first determine the total number of rendering times each client performs on the same rendering resource based on the rendering instruction sent by each client. Subsequently, rendering operations are performed according to the total number of rendering times to address the issue of repeated rendering of the same rendering resource, thereby improving the utilization rate and rendering efficiency of the rendering resources. The rendering method disclosed in the embodiment of the present application will be further explained below in conjunction with FIG. 4.

As shown in FIG. 4, the rendering method may include the following steps.

S201, determining a target rendering resource identifier corresponding to at least one client based on a resource identifier acquisition instruction sent by the at least one client.

S202, sending the target rendering resource identifier to the at least one client.

S203, receiving a rendering instruction sent by the at least one client, wherein the rendering instruction comprises the target rendering resource identifier.

S204, acquiring the client identifier and the target rendering resource identifier from the at least one rendering instruction, and determining the total number of rendering times for the same target rendering resource according to the target rendering resource identifier and the client identifier.

S205, determining a total number of rendering times for a same one of the target rendering resource according to the target rendering resource identifier and the client identifier.

The client identifier refers to the unique information of the client, such as a client serial number, which is not limited here.

Considering that the images to be rendered by the client may include interface elements, 2D images, or 3D images, when generating the rendering instruction based on the target rendering resource identifier, the client may create custom rendering instruction using preset rules tailored to the images to be rendered. Subsequently, the client sends the custom rendering instruction to the server, allowing the server to perform rendering operations based on the received custom rendering instruction.

The preset rules may be flexibly set as arbitrary rendering instruction generation rules based on the type of image that the client needs to render, which is not limited here. As an alternative implementation, when the type of image to be rendered is Android UI elements, then the preset processing rules may be to generate custom rendering instructions based on a DisplayList and the target rendering resource identifier. When the type of image to be rendered is a 2D or 3D image, or when directly manipulating the application interface of the Open Graphics Library (OpenGL) or Vulkan, then the preset processing rules may be to generate custom rendering instructions based on a modified graphic Application Programming Interface (API) and the target rendering resource identifier. The modified Graphics API refers to a new Graphics API that is modified based on a traditional Graphics API according to the target rendering resource.

It should be understood that OpenGL is a cross-language, cross-platform software programming interface used for rendering 2D images and 3D images, and Vulkan is a low-overhead, cross-platform application programming interface for 2D images and 3D images as well as computing.

In some alternative embodiments, considering that the server also includes a rendering instruction management module, as shown in FIG. 2, the server may parse each rendering instruction it receives from each client through the rendering instruction management module, so as to acquire the target rendering resource identifier and the client identifier from each rendering instruction. Next, the rendering instruction management module counts the total number of rendering times for the same target rendering resource based on the target rendering resource identifier and the client identifier. Subsequently, the rendering instruction management module renders the target rendering resource according to the total number of rendering times for the same target rendering resource to obtain the rendering result.

In some alternative embodiments, the rendering instruction management module renders the target rendering resource according to the total number of rendering times for the same target rendering resource, and alternatively, determines whether the total number of rendering times for the same target resource exceeds a preset number, which is an adjustable parameter, such as 0, 1, or 2.

In response to determining that the total number of rendering times for the same target resource exceeds the preset number, the target rendering resource is identified as needing to be rendered repeatedly. In this case, the rendering instruction management module may create a common rendering instruction based on all rendering instruction corresponding to the target rendering resource. The common rendering instruction is then stored in a common rendering instruction pool, and the target rendering resource corresponding to the common rendering instruction is stored in a common rendering resource pool. The rendering resources stored in the common rendering resource pool are acquired from the resource management module. Subsequently, when performing rendering operations based on the rendering instruction, the rendering instruction management module may render the target rendering resource corresponding to each common rendering instruction in the common rendering instruction pool by invoking the Graphics Processing Unit (GPU), thereby generating the rendering result needed by multiple clients. This approach avoids redundant rendering operations for the same rendering resource, saving GPU computational resources and achieving cross-client reuse of the same rendering resource, thus enhancing the utilization rate of rendering resources.

In response to determining that the total number of rendering times for the same target rendering resource is smaller than or equal to the preset number, the target rendering resource is identified as not needing repeated rendering. In this case, the rendering instruction management module may invoke the GPU to render the target rendering resource in the resource management module based on the rendering instruction corresponding to the target rendering resource, thus obtaining the rendering result.

Considering that some clients may obtain multiple target rendering resource identifiers from the server, the rendering instruction management module on the server, after acquiring multiple target rendering resource identifier and a client identifier from each rendering instruction sent by the clients, may determine the total number of rendering times for the target rendering resource corresponding to each target rendering resource identifier. In response to determining that the total number of rendering times for any first target rendering resource exceeds the preset number, common rendering instruction are obtained based on all rendering instruction corresponding to each first target rendering resource, and each common rendering instruction is stored in the common rendering instruction pool. The common rendering instruction only includes a first target rendering resource identifier. Further, the rendering instruction management module invokes the GPU to render the corresponding first target rendering resource in the common rendering resource pool based on each common rendering instruction in the common rendering instruction pool to obtain a rendering result. In response to determining that the total number of rendering times for any second target rendering resource is smaller than or equal to the preset number, the second target rendering resource in the resource management module is rendered based on rendering instruction corresponding to the second target rendering resource to obtain a rendering result. The rendering instruction corresponding to the second target rendering resource only includes a second target rendering resource identifier. In other words, the rendering instructions sent by the client may include identifiers for target rendering resources that need repeated rendering and those that do not need repeated rendering. In this case, the rendering instruction management module on the server may split the rendering instructions sent by the client into two categories: the first category includes only common rendering instructions corresponding to target rendering resource identifiers that need repeated rendering, and the second category includes personalized rendering instructions corresponding to target rendering resource identifiers that do not need repeated rendering.

The technical scheme disclosed in the embodiments of the present application determines target rendering resource identifier corresponding to at least one client based on resource identifier acquisition instruction sent by the at least one client, sends the target rendering resource identifier to the at least one client, and upon receiving rendering instruction sent by the at least one client, renders target rendering resource according to the target rendering resource identifier carried in the rendering instruction to obtain rendering result, and sends the rendering result to the corresponding client. In this way, by utilizing a server to uniformly manage the rendering instruction sent by each client and centrally execute rendering tasks corresponding to the rendering instruction, the technical scheme eliminates the need for each client to invoke a GPU for independent rendering, thereby avoiding the waste of GPU computational resources and improving the utilization rate of GPU computational resources. Additionally, the present application also uniformly manages rendering resources required by each client through the server, which improves rendering efficiency when the server executes the rendering tasks corresponding to the rendering instruction, and also allows for the reuse of rendering resources, thereby enhancing the utilization rate of rendering resources. Further, when multiple clients perform repeated rendering on the same rendering resource, the server may perform the rendering operation on the rendering resource just once, rather than conducting independent repeated renderings, which can further save GPU computational resources and enhances the rendering efficiency and utilization rate of rendering resources.

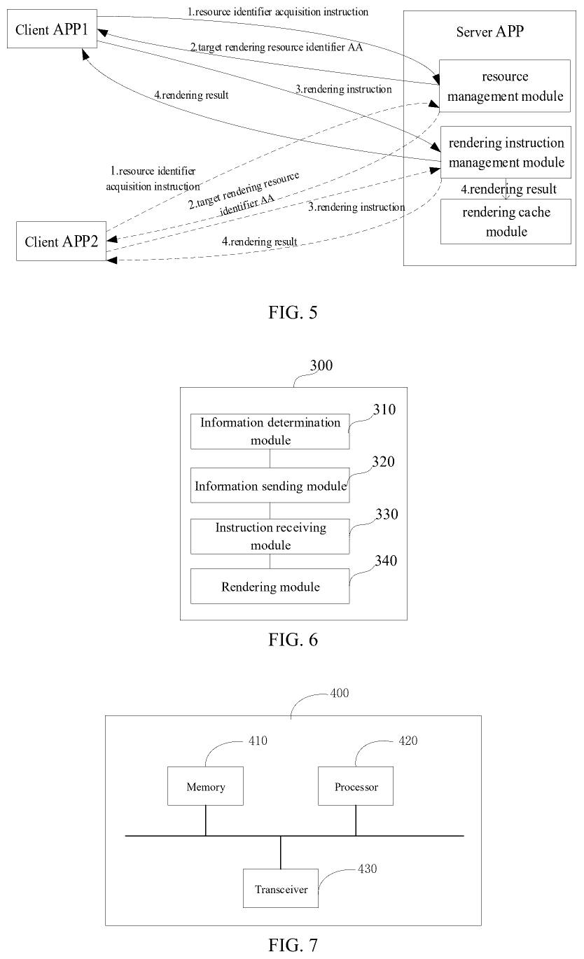

To provide a clearer explanation of the rendering method presented in the present application, the following example will be illustrated in conjunction with FIG. 5.

As shown in FIG. 5, suppose that a server and multiple clients are installed on a terminal device S, where the server is a server app, and the number of clients are two, namely client APP1 and client APP2. Client APP1 and client APP2 each establish a communication connection with the server APP. When both client APP1 and client APP2 are running on a terminal device A and simultaneously require image rendering, client APP1 may acquire image resource data XX1 that needs to be rendered and calculate verification information aa of the image resource data XX1 according to a data verification algorithm agreed upon with the server APP beforehand. And, client APP2 may acquire image resource data XX2 that needs to be rendered and calculate verification information bb of the image resource data XX2 according to the data verification algorithm agreed upon with the server APP beforehand. Next, client APP1 generates a resource identifier acquisition instruction based on the verification information aa, while client APP2 generates a resource identifier acquisition instruction based on the verification information bb. Both client APP1 and client APP2 send their respective resource identifier acquisition instruction to the server APP, enabling the server APP to acquire a target rendering resource identifier corresponding to the verification information aa carried by the resource identifier acquisition instruction from its own resource management module, as well as a target rendering resource identifier corresponding to the verification information bb carried by the resource identifier acquisition instruction.

When the server APP acquires the target rendering resource identifier corresponding to the verification information aa carried by the resource identifier acquisition instruction, as well as the target rendering resource identifier corresponding to the verification information bb carried by the resource identifier acquisition instruction, the verification information aa and bb may be compared with verification information of each rendering resource stored in the resource management module. In response to the verification information of the same rendering resource in the resource management module matching both aa and bb, an identifier AA of the rendering resource is taken as the target rendering resource identifier that Client APP1 and APP2 need to obtain.

Further, the server APP sends the target rendering resource identifier AA to client APP1 and client APP2. Subsequently, client APP1 and client APP2 generate custom rendering instruction based on their respective preset rules and send the custom rendering instruction to the server APP. Each custom rendering instruction carries the target rendering resource identifier AA. Upon receiving the rendering instruction from client APP1 and client APP2, the server APP uses a rendering instruction management module to parse each rendering instruction to acquire the target rendering resource identifier AA and a client identifier, namely APP1 and APP2, from the rendering instruction. Based on the client identifier APP1 and APP2, as well as the target rendering resource identifier AA, it is determined that both client APP1 and client APP2 require rendering of a target rendering resource corresponding to the target rendering resource identifier AA, and the total number of rendering times (2) exceeds the preset number (1). In this case, the rendering instruction management module treats the two rendering instructions corresponding to the target rendering resource identifier AA as a single common rendering instruction and stores the same in a common rendering pool, and acquires the target rendering resource corresponding to the common rendering instruction from the resource management module and stores the same in a common rendering resource pool. Then, the rendering instruction management module invokes a GPU to render the target rendering resource in the common rendering resource pool according to the common rendering instruction in the common rendering pool to obtain rendering result. Afterward, the server APP returns the rendering result to client APP1 and client APP2, while simultaneously storing the rendering result and the target rendering resource identifier in a rendering cache module. In this way, when subsequent clients render the target rendering resource, or when at least one of client APP1 or client APP2 renders the target rendering resource again, the server APP may directly acquire the rendering result from the rendering cache module and return the same to the clients, thereby avoiding repeated rendering of the same resource and unnecessary waste of GPU computational resources.

In other words, the rendering method disclosed in the embodiment of the present application can enhance the utilization rate of GPU computational resources, improve rendering efficiency, and facilitate the reuse of rendering resources, thereby increasing the utilization rate of rendering resources.

Next, with reference to FIG. 6, a rendering apparatus proposed in an embodiment of the present application will be described. The rendering apparatus is configured in an electronic device, which includes a server that executes the rendering apparatus. As shown in FIG. 6, the rendering apparatus 300 includes: an information determination module 310, an information sending module 320, an instruction receiving module 330, and a rendering module 340.

Here, the information determination module 310 is configured to determine a target rendering resource identifier corresponding to at least one client based on a resource identifier acquisition instruction sent by the at least one client;

the information sending module 320 is configured to send the target rendering resource identifier to the at least one client;

the instruction receiving module 330 is configured to receive a rendering instruction sent by the at least one client, the rendering instruction comprising the target rendering resource identifier; and

the rendering module 340 is configured to render a target rendering resource according to the target rendering resource identifier to obtain a rendering result, and send the rendering result to a corresponding client of the at least one client.

In an alternative implementation of the embodiment of the present application, the resource identifier acquisition instruction includes verification information of the target rendering resource, and the information determination module 310 includes:

an acquisition unit, configured to acquire the verification information of the target rendering resource from at least one resource identifier acquisition instruction; and

a determination unit, configured to determine the target rendering resource identifier corresponding to the at least one client from a resource management module according to the verification information of the target rendering resource.

In an alternative implementation of the embodiment of the present application, the determination unit is specifically configured to acquire a candidate rendering resource identical to the verification information in the resource management module according to the verification information of the target rendering resource, and determine a candidate rendering resource identifier corresponding to the candidate rendering resource as the target rendering resource identifier.

In an alternative implementation of the embodiment of the present application, at least two rendering resources are stored in the resource management module, and are stored according to a corresponding relationship among the rendering resource identifier, the verification information and the rendering resource.

In an alternative implementation of the embodiment of the present application, the rendering instruction further include a client identifier, and the apparatus further includes:
an identifier acquisition module, configured to acquire the client identifier from the at least one rendering instruction;
a data determination module, configured to determine a total number of rendering times for a same one of the target rendering resource according to the target rendering resource identifier and the client identifier; and
a rendering module, configured to render the target rendering resource according to the total number of rendering times for the same target rendering resource to obtain the rendering result.

In an alternative implementation of the embodiment of the present application, the rendering module is further configured to:
in response to the total number of rendering times for the same target rendering resource being more than a preset number, obtain a common rendering instruction according to all the rendering instruction corresponding to the target rendering resource, and store the common rendering instruction into a common rendering instruction pool, in which the common rendering instruction pool corresponds to one common rendering resource pool, and the target rendering resource is in the common rendering resource pool; and
render the corresponding target rendering resource in the common rendering resource pool according to the common rendering instruction to obtain the rendering result.

In an alternative implementation of the embodiment of the present application, the rendering module is further configured to:

in response to the total number of rendering times for the same one of the target rendering resource being smaller than or equal to a preset number, render the target rendering resource in a resource management module according to rendering instruction corresponding to the target rendering resource to obtain the rendering result.

It should be understood that the apparatus embodiments correspond to the method embodiments mentioned earlier, and similar descriptions can be found in the method embodiments. To avoid redundancy, this will not be elaborated upon further. Specifically, the apparatus 300 shown in FIG. 6 can execute the method embodiments corresponding to FIG. 1, and the aforementioned and other operations and/or functions of each module in the apparatus 300 are designed to implement the respective processes in the various methods illustrated in FIG. 1. For brevity, this will not be repeated here.

The apparatus 300 in the embodiment of the present application was described from the perspective of functional modules above with reference to attached drawings. It should be understood that these functional modules can be realized in hardware, software instructions, or a combination of both hardware and software modules. Specifically, each step of the method embodiment in the first aspect of the present application can be completed by integrated logic circuits in the hardware of a processor and/or software instructions. The steps of the method disclosed in the first aspect of the present application can be directly executed by a hardware decoding processor, or executed through a combination of hardware and software modules within the decoding processor. Alternatively, the software modules may reside in mature storage media such as random access memory, flash memory, read-only memory, programmable read-only memory, electrically erasable programmable memory, or registers. The storage media are located in a memory, and the processor reads the information stored therein to complete the steps of the method embodiment in the first aspect with its hardware.

FIG. 7 is a schematic block diagram of an electronic device provided by an embodiment of the present application. As shown in FIG. 7, the electronic device 400 may include a memory 410 for storing a computer program and transmitting the program code to the processor 420. In other words, the processor 420 can call and run a computer program from the memory 410 to realize the rendering method described in the first aspect in the embodiments of the present application.

For example, the processor 420 can be used to perform the above rendering method according to instructions in the computer program.

In some embodiments of the present application, the processor 420 may include, but is not limited to:
a general-purpose processor, a digital signal processor (DSP), an application specific integrated circuit (ASIC), a field-programmable gate array (FPGA) or other programmable logic device, a discrete gate, a transistor logic device, a discrete hardware component, etc. The general-purpose processor may be a microprocessor, or the processor may be any conventional processor, etc.

In some embodiments of the present application, the memory 410 may include, but is not limited to:

A volatile memory and/or a nonvolatile memory. Among them, the nonvolatile memory can be Read-Only Memory (ROM), programmable read-only memory (PROM), erasable programmable read-only memory (EPROM), electrically erasable programmable read-only memory (EEPROM) or flash memory. The volatile memory may be a Random Access Memory (RAM), which is used as an external cache. By way of illustration, but not limitation, many forms of RAM are available, such as static random access memory (SRAM), dynamic random access memory (DRAM), synchronous dynamic random access memory (Synchronous DRAM, SDRAM), Double Data Rate SDRAM synchronous dynamic random access memory (DDR SDRAM), enhanced synchronous dynamic random access memory (ESDRAM), synchronous link dynamic random access memory (SLDRAM) and direct memory bus random access memory (DR RAM).

In some embodiments of the present application, the computer program can be divided into one or more modules, which are stored in the memory 410 and executed by the processor 420 to complete the rendering method provided by the present application. The one or more modules can be a series of computer program instruction segments that can accomplish specific functions, and the instruction segments are used to describe the execution process of the computer program in the electronic device.

As shown in FIG. 7, the electronic device 400 may further include:
a transceiver 430 which can be connected to the processor 420 or the memory 410.

The processor 420 can control the transceiver 430 to communicate with other devices, specifically, the processor can send information or data to other devices or receive information or data sent by other devices. The transceiver 430 may include a transmitter and a receiver. The transceiver 430 may further include antennas, and the number of antennas may be one or more.

It should be understood that all components in the electronic device are connected through a bus system, and the bus system includes a power bus, a control bus and a status signal bus in addition to a data bus.

The present application also provides a computer storage medium, on which a computer program is stored, and the computer program, when executed by a computer, enables the computer to implement the rendering method described in the first aspect.

The present application also provides a computer program product containing program instructions, and the program instructions, when run on an electronic device, enable the electronic device to implement the rendering method described in the first aspect.

When implemented by software, the embodiments can be fully or partially implemented in the form of a computer program product. The computer program product includes one or more computer instructions. When the computer program instructions are loaded and executed on a computer, all or part of the processes or functions described in the embodiments of the present application are generated. The computer may be a general-purpose computer, a special-purpose computer, a computer network, or other programmable devices. The above computer instructions may be stored in a computer-readable storage medium or transmitted from one computer-readable storage medium to another. For example, the above computer instructions may be transmitted from one website, computer, server or data center to another website, computer, server or data center by wired (such as coaxial cable, optical fiber, digital subscriber line (DSL)) or wireless (such as infrared, wireless, microwave) means. The computer-readable storage medium may be any available medium that a computer can access or a data storage device such as a server or a data center that contains one or more available media. The available media may be magnetic media (such as floppy disk, hard disk, magnetic tape), optical media (such as digital video disc (DVD)), or semiconductor media (such as solid state disk (SSD)) and the like.

Those of ordinary skill in the art can realize that the modules and algorithm steps described in connection with the embodiments disclosed herein can be implemented in electronic hardware, or a combination of computer software and electronic hardware. Whether these functions are implemented by hardware or software depends on the specific application and design constraints of the technical scheme. Those skilled in the art can use different methods to realize the described functions for each specific application, but this implementation should not be considered beyond the scope of the present application.

In several embodiments provided by the present application, it should be understood that the disclosed system, apparatus and method can be realized in other ways. For example, the apparatus embodiment described above is only schematic. For example, the division of the modules is only a logical function division, and there may be other division methods in actual implementation. For another example, multiple modules or components may be combined or integrated into another system, or some features may be ignored or not implemented. Furthermore, the displayed or discussed coupling or direct coupling or communication can be indirect coupling or communication through some interfaces, apparatuses, or modules, which can be electrical, mechanical, or in other forms.

The modules described as separate components may or may not be physically separated, and the components displayed as modules may or may not be physical modules, i.e., may be located in one place or may be distributed over plurality of network units. Some or all of the modules can be selected according to actual needs to achieve the purpose of the embodiment. For example, all functional modules in each embodiment of the present application may be integrated into one processing module, or exist physically separated, or two or more modules may be integrated into one module.

In the embodiments of the present application, the term “module” or “unit” refers to a computer program or a part of a computer program with a predetermined function, and works with other related parts to achieve a predetermined goal, and can be realized in whole or in part by using software, hardware (such as a processing circuit or a memory) or a combination thereof. Similarly, a processor (or multiple processors or memories) can be used to implement one or more modules or units. Further, each module or unit can be a part of an overall module or unit that contains the functions of the module or unit.

The above description merely exemplifies specific implementations of the present application, but the protection scope of the present application is not limited to this. Any person familiar with the technical field can easily think of various modifications or substitutions within the technical scope disclosed by the present application, and these modifications or substitutions should fall within the protection scope of the present application. Therefore, the protection scope of the present application shall be subject to the protection scope of the claims.

1. A rendering method, applied to an electronic device, wherein the electronic device comprises a server and the rendering method is executed by the server, and the method comprises:
determining a target rendering resource identifier corresponding to at least one client based on a resource identifier acquisition instruction sent by the at least one client;
sending the target rendering resource identifier to the at least one client;
receiving a rendering instruction sent by the at least one client, wherein the rendering instruction comprises the target rendering resource identifier; and
rendering a target rendering resource according to the target rendering resource identifier to obtain a rendering result, and sending the rendering result to a corresponding client of the at least one client.

2. The method according to claim 1, wherein the resource identifier acquisition instruction comprises verification information of the target rendering resource, and determining the target rendering resource identifier corresponding to the at least one client based on the resource identifier acquisition instruction sent by the at least one client comprises:
acquiring the verification information of the target rendering resource from the resource identifier acquisition instruction; and
determining the target rendering resource identifier corresponding to the at least one client from a resource management module according to the verification information of the target rendering resource.

3. The method according to claim 2, wherein determining the target rendering resource identifier corresponding to the at least one client from a resource management module according to the verification information of the target rendering resource comprises:
acquiring a candidate rendering resource identical to the verification information in the resource management module according to the verification information of the target rendering resource; and
determining a candidate rendering resource identifier corresponding to the candidate rendering resource as the target rendering resource identifier.

4. The method according to claim 2, wherein at least two rendering resources are stored in the resource management module, and are stored according to a corresponding relationship among a rendering resource identifier, the verification information and the rendering resource.

5. The method according to claim 1, wherein the rendering instruction further comprise a client identifier, and the method further comprises:
acquiring the client identifier from the rendering instruction;
determining a total number of rendering times for a same one of the target rendering resource according to the target rendering resource identifier and the client identifier; and
rendering the target rendering resource according to the total number of rendering times for the same one of the target rendering resource to obtain the rendering result.

6. The method according to claim 5, wherein rendering the target rendering resource according to the total number of rendering times for the same one of the target rendering resource to obtain the rendering result comprises:
in response to the total number of rendering times for the same target rendering resource being more than a preset number, obtaining a common rendering instruction according to all the rendering instruction corresponding to the target rendering resource, and storing the common rendering instruction into a common rendering instruction pool, wherein the common rendering instruction pool corresponds to one common rendering resource pool, and the target rendering resource is in the common rendering resource pool; and
rendering the corresponding target rendering resource in the common rendering resource pool according to the common rendering instruction to obtain the rendering result.

7. The method according to claim 5, wherein rendering the target rendering resource according to the total number of rendering times for the same one of the target rendering resource to obtain the rendering result comprises:
in response to the total number of rendering times for the same one of the target rendering resource being smaller than or equal to a preset number, rendering the target rendering resource in a resource management module according to rendering instruction corresponding to the target rendering resource to obtain the rendering result.

8. The method according to claim 3, wherein at least two rendering resources are stored in the resource management module, and are stored according to a corresponding relationship among a rendering resource identifier, the verification information and the rendering resources.

9. The method according to claim 2, wherein the rendering instruction further comprise a client identifier, and the method further comprises:
acquiring the client identifier from the rendering instruction;
determining a total number of rendering times for a same one of the target rendering resource according to the target rendering resource identifier and the client identifier; and
rendering the target rendering resource according to the total number of rendering times for the same one of the target rendering resource to obtain the rendering result.

10. The method according to claim 3, wherein the rendering instruction further comprise a client identifier, and the method further comprises:
acquiring the client identifier from the rendering instruction;
determining a total number of rendering times for a same one of the target rendering resource according to the target rendering resource identifier and the client identifier; and
rendering the target rendering resource according to the total number of rendering times for the same one of the target rendering resource to obtain the rendering result.

11. The method according to claim 4, wherein the rendering instruction further comprise a client identifier, and the method further comprises:
acquiring the client identifier from the rendering instruction;
determining a total number of rendering times for a same one of the target rendering resource according to the target rendering resource identifier and the client identifier; and
rendering the target rendering resource according to the total number of rendering times for the same one of the target rendering resource to obtain the rendering result.

12. An electronic device, comprising:
a processor and a memory, wherein the memory is configured to store a computer program, and the processor is configured to call and run the computer program stored in the memory to execute a rendering method;
the rendering method is applied to the electronic device, the electronic device comprises a server and the rendering method is executed by the server, and the method comprises:
determining a target rendering resource identifier corresponding to at least one client based on a resource identifier acquisition instruction sent by the at least one client;
sending the target rendering resource identifier to the at least one client;
receiving a rendering instruction sent by the at least one client, wherein the rendering instruction comprises the target rendering resource identifier; and
rendering a target rendering resource according to the target rendering resource identifier to obtain a rendering result, and sending the rendering result to a corresponding client of the at least one client.

13. The electronic device according to claim 12, wherein the resource identifier acquisition instruction comprises verification information of the target rendering resource, and determining the target rendering resource identifier corresponding to the at least one client based on the resource identifier acquisition instruction sent by the at least one client comprises:
acquiring the verification information of the target rendering resource from the resource identifier acquisition instruction; and
determining the target rendering resource identifier corresponding to the at least one client from a resource management module according to the verification information of the target rendering resource.

14. The electronic device according to claim 13, wherein determining the target rendering resource identifier corresponding to the at least one client from a resource management module according to the verification information of the target rendering resource comprises:
acquiring a candidate rendering resource identical to the verification information in the resource management module according to the verification information of the target rendering resource; and
determining a candidate rendering resource identifier corresponding to the candidate rendering resource as the target rendering resource identifier.

15. The electronic device according to claim 13, wherein at least two rendering resources are stored in the resource management module, and are stored according to a corresponding relationship among a rendering resource identifier, the verification information and the rendering resources.

16. The electronic device according to claim 12, wherein the rendering instruction further comprise a client identifier, and the method further comprises:
acquiring the client identifier from the rendering instruction;
determining a total number of rendering times for a same one of the target rendering resource according to the target rendering resource identifier and the client identifier; and
rendering the target rendering resource according to the total number of rendering times for the same one of the target rendering resource to obtain the rendering result.

17. The electronic device according to claim 16, wherein rendering the target rendering resource according to the total number of rendering times for the same one of the target rendering resource to obtain the rendering result comprises:
in response to the total number of rendering times for the same target rendering resource being more than a preset number, obtaining a common rendering instruction according to all the rendering instruction corresponding to the target rendering resource, and storing the common rendering instruction into a common rendering instruction pool, wherein the common rendering instruction pool corresponds to one common rendering resource pool, and the target rendering resource is in the common rendering resource pool; and
rendering the corresponding target rendering resource in the common rendering resource pool according to the common rendering instruction to obtain the rendering result.

18. The electronic device according to claim 16, wherein rendering the target rendering resource according to the total number of rendering times for the same one of the target rendering resource to obtain the rendering result comprises:
in response to the total number of rendering times for the same one of the target rendering resource being smaller than or equal to a preset number, rendering the target rendering resource in a resource management module according to rendering instruction corresponding to the target rendering resource to obtain the rendering result.

19. The electronic device according to claim 14, wherein at least two rendering resources are stored in the resource management module, and are stored according to a corresponding relationship among a rendering resource identifier, the verification information and the rendering resources.

20. A non-transitory computer-readable storage medium containing computer-executable instructions, wherein the computer-executable instructions, when executed by a computer processor, are used to execute a rendering method;
the rendering method is applied to the electronic device, the electronic device comprises a server and the rendering method is executed by the server, and the method comprises:
determining a target rendering resource identifier corresponding to at least one client based on a resource identifier acquisition instruction sent by the at least one client;
sending the target rendering resource identifier to the at least one client;
receiving a rendering instruction sent by the at least one client, wherein the rendering instruction comprises the target rendering resource identifier; and
rendering a target rendering resource according to the target rendering resource identifier to obtain a rendering result, and sending the rendering result to a corresponding client of the at least one client.
